(19) United States
(12) Patent Application Publication
(10) Pub. No.: US 2006/0144659 A1
(43) Pub. Date: Jul. 6, 2006

(54) Tuned absorbers for railway rails

(75) Inventors: Anbin Wang, Woking (GB); Christopher Neil Morison, Surrey (GB); Peter Rickard Shrubsall, Ottery St. Mary (GB); Richard Guy Bointon, Yealmpton (GB)

Correspondence Address: GOTTLIEB RACKMAN & REISMAN PC, 270 MADISON AVENUE, 8TH FLOOR, NEW YORK, NY, 100160601, US

(73) Assignee: Pandrol Limited

(21) Appl. No.: 11/363,903

(22) Filed: Feb. 28, 2006

Related U.S. Application Data
(62) Division of application No. 10/562,753.

(30) Foreign Application Priority Data
Jul. 11, 2003 (GB) 0316307.8

(51) Int. Cl. F16F 7/10

(52) U.S. Cl. 188/379

(57) ABSTRACT

A tuned absorber (5A, 5B) for attachment to a railway rail (1) comprises a body (6) formed of elastomeric material and of at least one region of a first material, denser than the elastomeric material, located within the elastomeric material and forming an active mass (7m₁, 7m₂, 7m₃). A member (8) of a second material denser than the elastomeric material is also located within the elastomeric material, adjacent to the active mass (7m₁, 7m₂, 7m₃), for coupling to the rail (1) so as to provide a resonant surface against which the active mass (7m₁, 7m₂, 7m₃) can vibrate. Alternatively, or in addition, a tuned absorber (5A, 5B) has a first active mass (7m₁) and at least one further active mass (7m2, 7m3) arranged so as to be effectively coupled for vibration in a first frequency range and such that the or each further active mass (7m₂, 7m₃) is decoupled from the first active mass (7m₁) for vibration in a second frequency range higher than the first. Alternatively, or in addition, attachment means for applying a securing force to maintain a tuned absorber (5A, 5B) in position on the rail web (1c) comprise a spring steel strap (40) having an overcentre device which locates on the rail foot (1b) and is operable, when snapped into a closed position, to apply a compressive force to the tuned absorber (5A, 5B).

The present invention relates to tuned absorbers for railway rails and to assemblies incorporating such tuned absorbers.

Vibrations occur in railway track components and supporting structures when trains pass. The frequency range of greatest interest is from about 50 Hz to perhaps 5 kHz. As a result of these vibrations, sound is emitted from the vehicles, the track, and the support structure. The principle source of the vibrations most relevant to sound emission is the dynamic contact force which results from roughness on the wheels of the train and on the rail. One approach to noise control on railways is therefore to reduce rail and wheel roughness, for instance by grinding the rail, or by attempting to select components which reduce the rate of roughness growth. However, such measures may be expensive. The largest contributions to total so called “rolling noise” are from the rail and the wheels of the vehicles.

In terms of mechanical performance—dynamic forces transmitted to the sleeper, rate of track settlement, rail roughness growth and so on, the stiffness of the track support is preferably reduced. An associated effect is that vibrations are instead transmitted further along the rails. The change in track stiffness can therefore be expected to affect the total noise emitted in two contradictory ways—there may be a decrease in the noise component from the track support structure, but an increase in that from the rail. The extent to which any net change is beneficial will depend on a large number of factors—among them the change in track stiffness which can be brought about; the relative contributions from the rail and the track support structure; the frequency ranges of the vibrations of the different elements; and the design of the support structure.

Providing damping directly on the track components is unlikely to make a sufficient contribution to improve overall noise levels significantly, and has the disadvantage that the components may deteriorate rapidly because of the energy absorption associated with damping. In order to reduce the noise from the rail, tuned absorbers have been developed in the last ten years. As disclosed in EP-B-0628660 and WO99/15732, a tuned absorber comprises a body of elastomeric material which is attached to a surface of the rail and contains one, or preferably more, active masses made of denser material and tuned to resonant frequencies within the range of vibration frequencies of the rail.

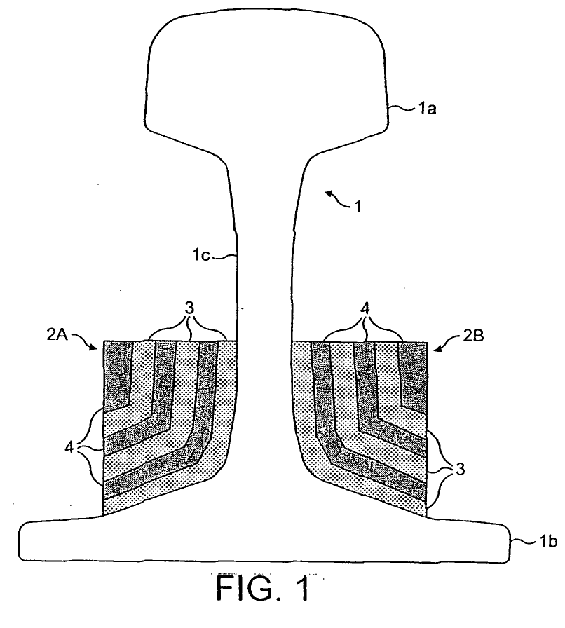

As shown in FIG. 1 of the accompanying drawings, a tuned absorber 2A (2B) in accordance with the teaching of WO99/15732 comprises alternating layers of elastomeric material 3 and nested active masses 4 of denser material. The tuned absorber 2A (2B) is located on the foot, 1b of the rail 1 so as to contact the rail web 1c.

Using a tuned absorber of the type disclosed in WO99/15732, having two tuning frequencies and a relatively high damping loss factor, noise reduction of about 6 dB(A) can be achieved over a broad frequency range centred on the peak in rail noise around 1 kHz. However, this prior art absorber is made by gluing continuous layers to a rail before the rail is installed in track. Other existing designs, for example using a threaded system or bolted components to hold the absorbers on the rail foot, are also very difficult to attach to an existing piece of track.

It is therefore desirable to provide an improved method of, or an improved assembly for, mounting a tuned absorber on a railway rail.

According to a first aspect of the present invention, there is provided a method of mounting a tuned absorber on a web of a railway rail, which method comprises the steps of: pinbrazing onto the rail web at least two studs at preselected locations; bringing the tuned absorber into abutment with the rail web such that the studs extend into respective holes formed through the tuned absorber; and applying a releasable fastening to each stud so as to maintain the tuned absorber thereon in contact with the rail web. Preferably, the studs are threaded and the said releasable fastening comprises a nut.

Pinbrazing (for example, using equipment supplied by Safetrack Bavhammar AB, Sweden) is a very quick and effective method of brazing (low-temperature welding) a connection to a rail. Many railway companies already approve the brazing technique for making safety critical electrical connections and have done so for many years. Although mainly used for connecting electrical cables to rails, it can also be used to attach studs.

Attaching tuned absorbers using such a pinbrazing method has many advantages. It is considerably quicker and cheaper than gluing the absorber to the rail or attaching it using clips. Since the fastenings are releasable the absorber can also be removed very easily. Furthermore, since no external clips are required the absorber does not extend beyond the profile of the rail and hence can be used at locations where width or under-foot clearance is limited; the tuned absorber could be even be designed to fit at the location of most standard rail fastenings. Another advantage is that the small mass of the attaching system means that in situations where there is a specified limit on total assembly mass, more of that mass can be allocated to the active mass of the tuned absorber.

Alternatively, according to a second aspect of the present invention, there is provided a tuned absorber assembly for a railway rail, which assembly comprises tuned absorbers for respectively abutting each side of a web of the rail and a resilient clip for applying a securing force to maintain the absorbers in position on the tail web, wherein each tuned absorber has means for securing the clip thereto.

Preferably, the securing means comprise sockets formed in respective faces of the tuned absorbers for receiving respective free ends of the clip. Desirably, the centre line of all parts of the clip lie substantially in the same plane except for the free ends thereof, which free ends extend out of the said plane in substantially mutually-opposite directions, and the sockets being formed in end faces of the said tuned absorbers. The sockets may be formed as part of a channelled member located within the said tuned absorber.

As a further alternative, according to a third aspect of the present invention, there is provided a tuned absorber assembly for a railway rail comprising a tuned absorber for abutting a web of the rail and attachment means for applying a securing force to maintain the absorber in position on the rail web, wherein the said attachment means comprise a spring steel strap having a first portion for location on the tuned absorber, a second portion for attachment to a foot of the rail, and a flat third portion, joining the first and second portions, for location under the rail foot.

Preferably, the second portion of the strap comprises an overcentre device which locates on the rail foot and is operable, when snapped into a closed position, to apply a compressive force to the tuned absorber through the first and third portions of the strap. Desirably, the tuned absorber has a socket for locating the said first portion of the strap.

The problem of rail noise has also been addressed by the applicants in EP-B-0758418 which discloses a suspended rail fastening assembly comprising a pair of elastic members for supporting the head of the rail and a pair of brackets arranged for applying a lateral clamping force to respective ones of the elastic members. The applicants now propose that each of the elastic members comprises elastomeric material within which is located at least one active mass, formed of material denser than the elastomeric material, such that the elastic member serves as a tuned absorber.

According to a fourth aspect of the present invention, there is provided an assembly for mounting tuned absorbers on a railway rail, the tuned absorbers each comprising a member of elastomeric material containing at least one active mass, of material denser than said elastomeric material, the tuned absorbers being arranged on each side of the web of the rail such that the head of the rail contacts the tuned absorbers, wherein the assembly comprises a pair of brackets arranged for applying a lateral clamping force to respective ones of the tuned absorbers, whereby the rail is suspended above a rail foundation.

This mounting assembly has the significant advantage that it is integral with the rail suspension assembly and therefore requires no extra installation time or attachment methods. It is also hidden and as such is not prone to damage or vandalism.

It is also desirable to provide an improved tuned absorber.

The natural frequency of a mass vibrating on a supported layer of elastomer is proportional to the square root of the stiffness of the elastomer layer and inversely proportional to the square root of the mass. Therefore a small mass or a high-stiffness layer of elastomer is required to achieve a high natural frequency. But since a heavier mass can absorb more energy, it is in the interests of efficiency to use a high mass, and therefore a high-stiffness layer of elastomer is required.

The stiffness of the elastomer layer is inversely proportional to its thickness. However, a layer that is too thin will be more difficult to manufacture to tolerance and will deteriorate more rapidly. A solution to this design contradiction is to support the mass with the elastomer material on both sides; thus a layer of elastomer on both sides of the mass will have twice the stiffness as the same thickness of elastomer on only one side, provided that both layers of elastomer are rigidly connected to the rail.

According to a fifth aspect of the present invention, there is provided a tuned absorber for attachment to a railway rail, which absorber comprises a member formed of elastomeric material and of at least one region of a first material which is denser than the said elastomeric material; which region is located within the said elastomeric material and forms an active mass, wherein a member of a second material denser than the said elastomeric material is also located within the said elastomeric material, adjacent to the said active mass, which member is coupled to the rail when in use so as to provide a resonant surface against which the said active mass can vibrate.

In essence, the presence of the member increases the stiffness of the system, allowing a higher active mass to be fitted within a given profile, and allowing the use of thicker, more durable layers of elastomer.

Preferably, the member is semi-rigidly attached to the rail when the absorber is in use. In this case, the member may have at least two holes therethrough for receiving attachment means whereby the member may be attached to a rail when the absorber is in use.

Although the member preferably comprises a beam, this is not essential. If the active mass(es) is(are) not elongate then the member needs to be present only at discrete locations near the mass(es). Even if the mass is elongate the member need not run for the entire length of the mass; for example although providing less stiffness, the member could run parallel to the mass for only a short length either side of each absorber fixing (if the member is used to locate such fixings) or be just an annular sleeve around the fixing.

The beam is preferably shaped so as to have a channel running therealong, thereby reducing its mass whilst maintaining an acceptable bending stiffness and providing flat surfaces parallel to the active mass(es). However, it could be a solid block; or have a hollow rectangular section, which has the advantage of providing large flat surfaces on all sides; or a flat plate, provided that the required natural frequencies and mode-shapes could be achieved. Preferably, the first and second denser materials comprise the same material.

WO99/15732 discloses multiple masses which are nested within each other, one of the active masses being an elongate solid section, positioned in the angle of another with two faces at a corresponding angle. The mass per unit length of the angled active mass is significantly greater than the others.

The reason for this requirement is that to achieve higher resonant frequencies smaller and smaller masses are required, and to achieve efficient transfer of both vertical and lateral vibration from the rail to the masses, these masses are of similar profile and nested within each other. Another advantage of this nesting is that at lower frequencies adjacent masses will couple together to produce a combined active mass. However, the deficiency with this design is that at the higher frequencies the active mass gets successively smaller and the ability of the system to absorb energy is reduced.

According to a sixth aspect of the present invention, there is provided a tuned absorber for attachment to a railway rail, which absorber comprises a member formed of elastomeric material and of a first active mass and at least one further active mass, which active masses are of a material which is denser than the said elastomeric material and are located within the said elastomeric material, wherein the first active mass and the or each further mass are arranged so as to be effectively coupled for vibration in a first frequency range and such that the or each further active mass is decoupled from the first mass for vibration in a second frequency range higher than the first.

Preferably, the absorber further comprises a member of a material denser than the said elastomeric material located within the said elastomeric material adjacent to the or each further active mass, which member is coupled to the rail when the absorber is in use so as to provide a resonant surface against which the or each further active mass can vibrate.

The presence of the beam improves the transfer of vertical and lateral vibration from the rail to the active masses and thus removes the requirement of nested masses. The beam allows greater flexibility in the arrangement of active masses and enables larger active masses to be active at higher frequencies.

In the prior art, the active masses are solid members of a dense material. However, according to a seventh aspect of the present invention, there is provided a tuned absorber for attachment to a railway rail, which absorber comprises a member formed of elastomeric material and of at least one region of material forming an active mass which is located within, but is denser than, the said elastomeric material, wherein the said active mass comprises a multiplicity of unconnected pieces of said denser material. As the unconnected pieces are free to vibrate individually or in combination with any of the other pieces, such a system has considerably more degrees of freedom than lumped masses and thus would be effective at absorbing vibrations across a broader bandwidth, especially if pieces of differing diameter are used. Thus, the pieces of said multiplicity preferably differ in size from one another.

Desirably, the pieces of said multiplicity are surrounded by an elastomeric material, a viscous liquid or air. Preferably, the said pieces comprise spherical balls.

Employing a viscous liquid as the filler in-between the balls would cause energy to be absorbed through drag and acceleration reaction forces, rubbing and rotation of the balls as well as inertial forces, and the balls would not suffer from wear as much as a solid filler.

It should be noted that the above-mentioned first to seventh aspects of the present invention may be used separately or in any combination.

Reference will now be made, by way of example, to the accompanying drawings, in which:

FIG. 1 (described above) shows an end view of a rail provided with a prior art tuned absorber;

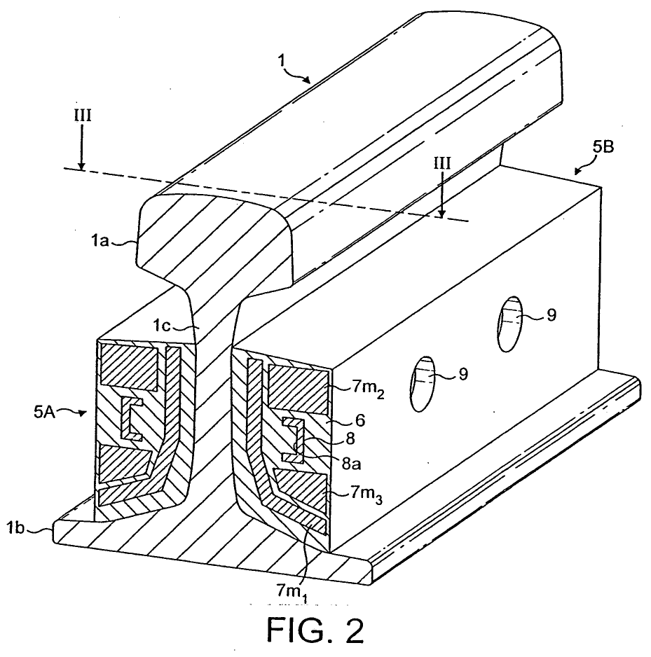

FIG. 2 shows a perspective view of a rail provided with a tuned absorber embodying the present invention;

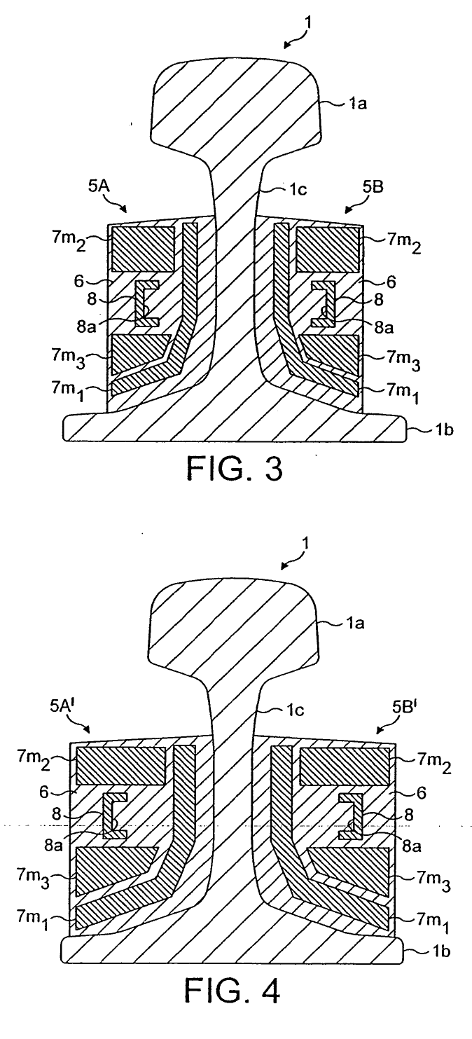

FIG. 3 shows a cross-sectional view taken on the line III-III in FIG. 2;

FIG. 4 shows a modified version of the tuned absorber shown in FIG. 3;

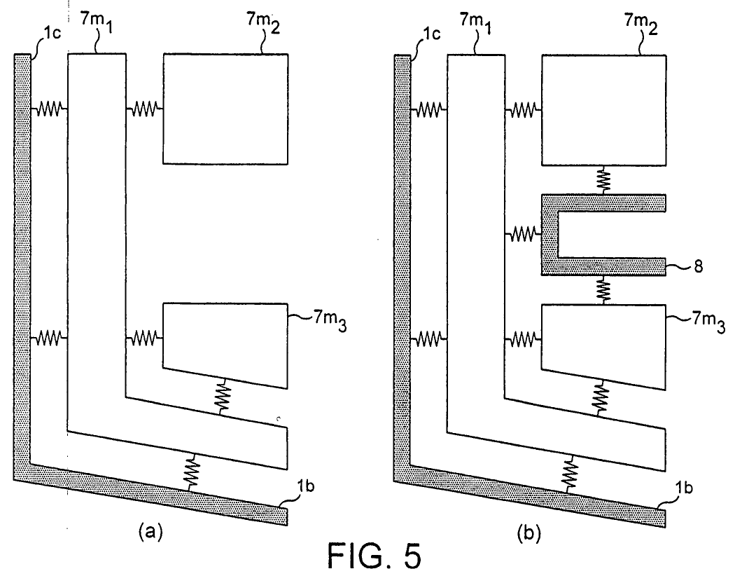

FIG. 5 shows diagrams of the tuned absorber when considered as a system of sprung masses, FIGS. 5A and 5B showing respectively the systems without and with a beam;

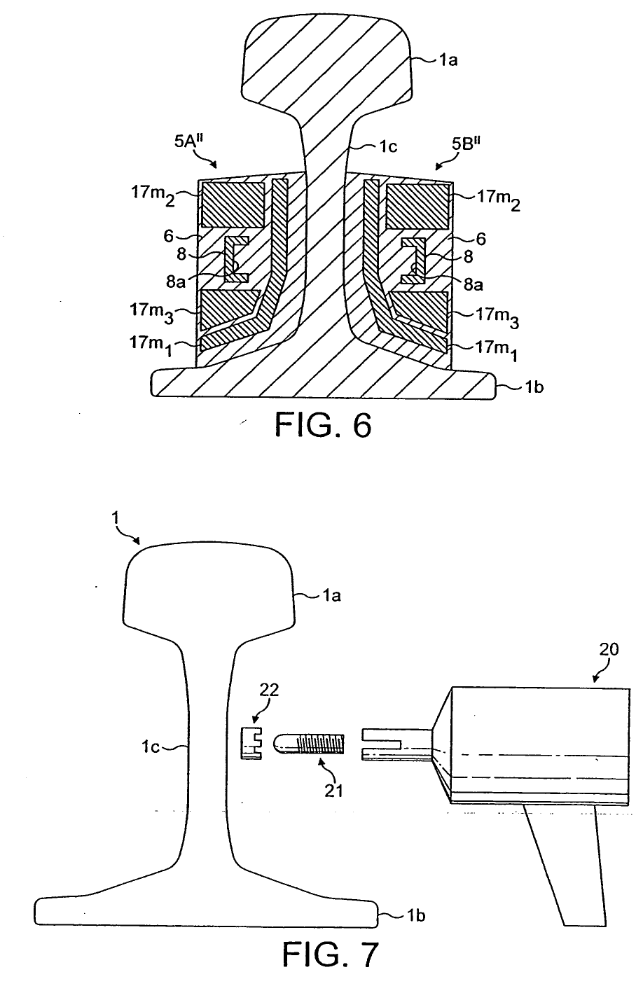

FIG. 6 shows a cross-sectional view of a tuned absorber assembly in which the tuned absorber has non-solid active masses;

FIG. 7 shows a diagram for use in explaining a method of attaching a tuned absorber to a rail;

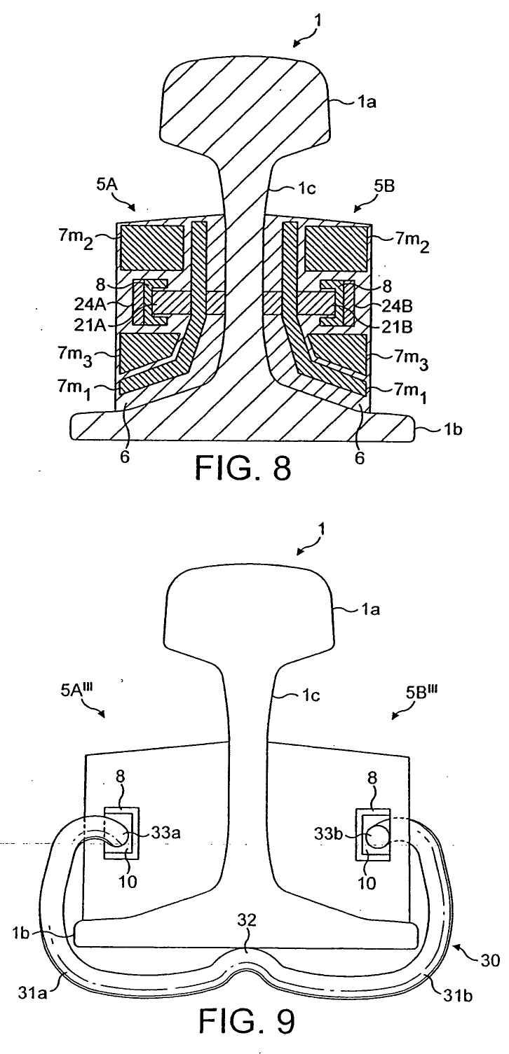

FIG. 8 shows a tuned absorber attached to a rail in accordance with the method of FIG. 7;

FIG. 9 shows an alternative way of securing tuned absorbers to a rail;

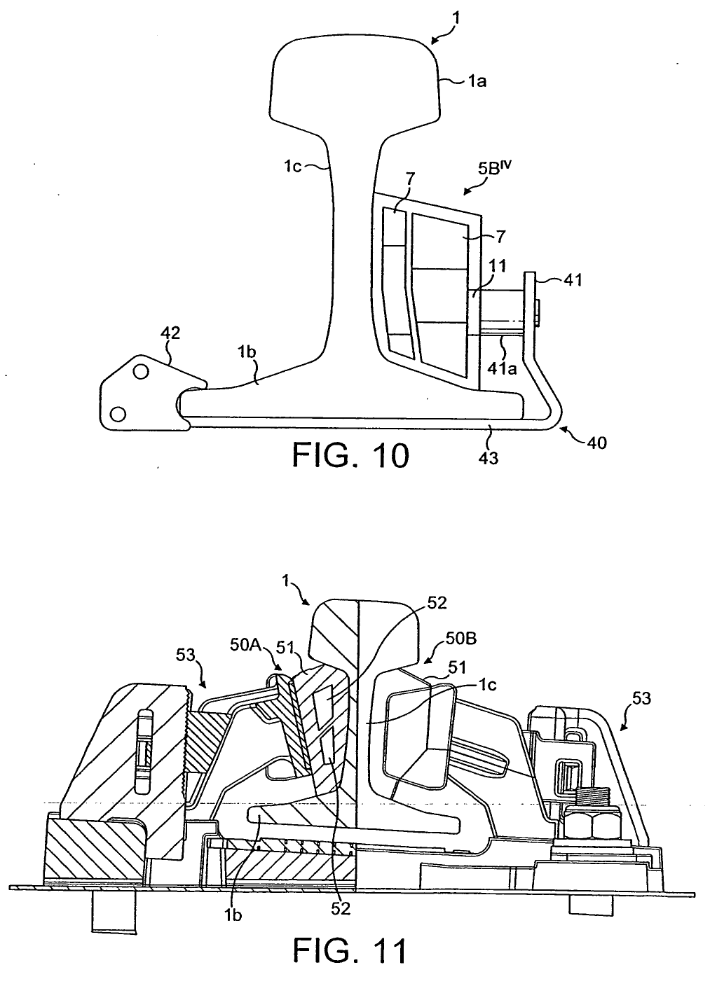

FIG. 10 shows yet another alternative way of securing a tuned absorber to a rail; and

FIG. 11 shows a way in which a tuned absorber may be incorporated into an existing rail fastening system.

FIGS. 2 and 3 show a pair of tuned absorbers 5A, 5B embodying the present invention installed on a railway rail 1 having a head 1a, a foot 1b and an interconnecting rail web 1c. The tuned absorbers 5A, 5B are shaped so that they rest on the rail foot 1b in abutment with and on either side of the rail web 1c. Each tuned absorber 5A, 5B comprises an elastomeric body 6 shaped so as to fit in the space defined by the rail web and rail foot and containing three active masses 7m₁, 7m₂ and 7m₃ and a beam 8 provided with a channel 8a on the side of the beam facing inwardly towards the rail web 1c. On the outwardly-facing side of the elastomeric body 6 there are formed two holes 9 which extend across the elastomeric body 6 to the opposite side thereof which abuts the rail web 1c. The beam 8 is also formed with correspondingly located holes (not shown). As will be explained later in more detail, these holes are provided for receiving respective studs whereby the tuned absorbers 5A, 5B may be mounted on the rail. The beam 8 serves as a support for such mounting means and for the absorber itself.

As shown in FIG. 4, if desired the tuned absorber 5A′ may extend across the width of the rail foot 1b. Although not shown, the tuned absorber 5A, 5A′ may also extend further in an upwardly direction, unless for some reason clearance from the rail head 1a is required.

In addition to providing an attachment point between the chosen fastening system and the tuned absorber, the channelled beam 8, being semi-rigidly attached to the rail, effectively provides an extension of the rail surface within the heart of the absorber and therefore plays a significant part in the design and efficiency of the system, changing the system from that shown in FIG. 5a to that shown in FIG. 5b. For example, in FIG. 5a, mass 7m₂ is only softly supported in a vertical direction and will therefore have a very low resonant frequency. However, with the presence of the beam 8 in FIG. 5b active mass 7m₂ is supported vertically by only a very thin stiff layer of elastomeric material and hence will have a much higher resonant frequency.

In order to use the active mass effectively for tuning frequencies in both vertical and lateral directions, the distribution of active masses is preferably optimised based on FE modal analysis.

The requirement for multiple lateral and vertical natural frequencies using a limited active mass and within a limited space led to the arrangement shown in FIG. 3, in which there are three active masses on each side. Some advantages of this arrangement are:

i) At lower frequencies all three active masses 7m₁, 7m₂, 7m₃ are effectively coupled and vibrate on the thick layer of elastomeric material between mass 7m₁ and the rail 1.

ii) The “L” shape of mass 7m₁ means that both vertical and lateral vibrations are transferred to the active masses.

iii) At higher frequencies the masses 7m₂ and 7m₃ become decoupled from the mass 7m₁ and vibrate on the thin layer of elastomeric material between themselves and 7m₁ and also between themselves and the beam 8.

iv) Vertical and lateral bending modes are also present at higher frequencies.

By way of example, in one embodiment of the invention, the active masses may be made of steel and have the following mass: m₁=1.43 kg, m₂=1.27 kg, m₃=0.78 kg, amounting to a total active mass of 3.48 kg per side. If the sleeper spacing is of 0.6 m, the active mass per meter rail is 11.6 kg/m. In this example, the elastomeric material is rubber having a mass of 0.60 kg per side and the support beam mass is 0.26 kg per side, resulting in a tuned absorber having a total mass of 4.34 kg per side. If the sleeper spacing is 0.6 m, the total mass is 14.47 kg/m (24% of the rail mass).

It is believed that such a tuned absorber would have the following natural frequencies: 720 Hz—vertical & lateral; 947 Hz—vertical & rotation; 12.72 Hz—lateral; 1427 Hz—vertical bending; 1627 Hz—vertical; 1681 Hz—lateral bending; 1856 Hz—lateral bending.

As illustrated in FIG. 6, the active masses of the tuned absorbers 5A¹¹ and 5B¹¹ could advantageously comprise a multiplicity of unconnected pieces of material rather than solid steel bars. For example, the active masses 17m₁, 17m₂ and 17m₃ in the tuned absorbers 5A¹¹ and 5B¹¹ comprise a volume filled with small, spherical balls surrounded by a viscous liquid, elastomeric material or air. For an efficient and compact tuned absorber, the balls would be formed of a material having high density.

As mentioned previously, the tuned absorber 5A, 5B of FIG. 2 is mounted on the rail 1 by means of a stud which passes through holes 9 in the tuned absorber 5A, 5B. As illustrated in FIG. 7, each stud 21 is secured to the rail web 1c by pin brazing. The pin brazing process is very quick and simple. Firstly, the target areas and an earth connection point are prepared with a small grinder and the earth connection attached. An electrical brazing gun 20 provides an arc to create heat to melt brazing solder on the end of the stud 21, which is thereby brazed to the rail 1 in a matter of seconds (the brazing process being confined to the area defined by ferrule 22). When each stud 21 is in place the holes 9 in the tuned absorber 5A, 5B are aligned with the studs 21 and the tuned absorber 5A, 5B is moved into abutment with the rail web 1c. When the absorber 5A, 5B is in place, it is secured in position. In this embodiment, as illustrated in FIG. 8, studs 21A, 21B are threaded and the absorber 5A, 5B is secured in position by respective nuts 24A, 24B. When using releasable fastenings, such as nuts on threaded studs, the tuned absorber 5A, 5B can be removed as and when required. Thus, although the tuned absorber is pre-formed before attachment, it is not bonded to the rail unlike in the prior art.

If for some reason it is not desirable or appropriate to mount the tuned absorbers 5A, 5B on the rail 1 using pinbrazed studs 21 as described above, other mounting methods may be used.

One alternative is to use a clip 30 as shown in FIG. 9. Clip 30 is shaped so as to have two C-shaped portions 31a, 31b which extend from a portion 32 in contact with the underside of the rail, each C-shaped portion 31a, 31b having an end portion 33a, 33b for attachment to the tuned absorber 5A¹¹¹, 5B¹¹¹. The tuned absorbers 5A¹¹¹, 5B¹¹¹ have respective sockets 10 for receiving the ends 33a, 33b of the clip 30, the ends 33a, 33b extending at approximately 90° to the C-shaped portions 31a, 31b in opposite directions parallel to the rail. The clip 30 is almost flat in the vertical plane (apart from at the ends 33a, 33b) and can therefore be used to apply a preload to each tuned absorber by being placed in a substantially flat horizontal orientation, passed under the rail foot, then rotated back into the vertical plane and pulled open. The ends 33a, 33b are then released into the sockets 10. The sockets 10 may be provided by shoulders built into the channel 8a of beam 8 (the orientation of which channel is reversed compared to that shown in FIG. 2). If the beam 8 were not provided then sockets could be embedded into the elastomeric material. Recesses could be provided at discrete positions within the active masses to provide space for such sockets if necessary.

Another means for securing the tuned absorber on the rail in shown in FIG. 10. In this case, the tuned absorber 5B^{IV} is held by means of a spring steel strap 40. The strap 40 has a first portion 41 extending alongside the tuned absorber 5B^{IV} from which there extends a locating portion 41a which locates on a casting strue 11 of one of the active masses in the tuned absorber 5B^{IV}. The strap 40 has a portion 43 which passes under the rail 1b and is connected to an over centre device 42 which locates on the foot 1b of the rail 1 on the opposite side to the tuned absorber 5B^{IV} and can be snapped up into position so providing a compressive force on the tuned absorber 5B^{IV} against the web 1c of the rail 1. This over centre device 42 can be locked in a closed position as shown in the Figure.

The type of tuned absorber proposed in this application, in which a solid mass is suspended in an elastomeric material, could conveniently be incorporated into a fastening assembly in which the rail is supported under its head on elastic wedge elements, as proposed in the applicant's EP-B-0758418. In this rail fastening system a gap is created under the rail foot into which the rail can deflect under load, allowing considerable reduction in stiffness whilst providing adequate control of roll and gauge. Provided that the load transferring ability and resilience of the elastic wedge element can be maintained, it is possible to insert one or more solid masses into the elastic wedge, the shape and size of which can be tuned to provide vibration absorption at the required frequencies. This is illustrated in the assembly of FIG. 11, in which brackets 53 apply a load to elastic wedge elements 50A, 50B comprising elastomeric members 51 containing active masses 52.

1-22. (canceled)

23. An assembly for mounting tuned absorbers on a railway rail, the tuned absorbers each comprising a member of elastomeric material containing at least one active mass, of material denser than said elastomeric material, the tuned absorbers being arranged on each side of the web of the rail such that the head of the rail contacts the tuned absorbers, wherein the assembly comprises a pair of brackets arranged for applying a lateral clamping force to respective ones of the tuned absorbers, whereby the rail is suspended above a rail foundation.

24. A suspended rail fastening assembly comprising a pair of elastic members for supporting the head of the rail and a pairs of brackets arranged for applying a lateral clamping force to respective ones of the elastic members, wherein each of the elastic members comprises eleastomeric material within which is located at least one active mass, formed of material denser than the elastomeric material, such that the elastic member serves as a tuned absorber.
